(19) United States
(12) Patent Application Publication
(10) Pub. No.: US 2026/0225514 A1
(43) Pub. Date: Aug. 6, 2026

(54) Inflatable RV Slide Topper Support Device

(71) Applicants: George Jones, Sanford, NC (US); Amy Jones, Sanford, NC (US)

(72) Inventors: George Jones, Sanford, NC (US); Amy Jones, Sanford, NC (US)

(21) Appl. No.: 19/398,133

(22) Filed: Nov. 24, 2025

Related U.S. Application Data
(60) Provisional application No. 63/753,083, filed on Feb. 3, 2025.

(51) Int. Cl. B60P 3/34; C09D 5/14; C09D 5/16

(52) U.S. Cl. CPC B60P 3/341; C09D 5/14; C09D 5/16

(57) ABSTRACT

An inflatable RV slide topper support device is provided. The device is configured to provide structural elevation beneath fabric-based side toppers typically installed on recreational vehicle slide-outs. The inflatable RV slide topper support device comprises a primary inflatable body that may be tubular in shape. In certain embodiments, the body comprises a plurality of independently inflatable air chambers that allow user to tailor the support profile based on uneven sagging conditions. The device further comprises at least one inflation valve compatible with manual or powered inflation tools. An exterior surface of the inflatable body may be textured with embossed or patterned regions to enhance friction and prevent slippage against the slide topper and RV roof. The inflatable RV slide topper support device additionally comprises a mounting system that includes reinforced loops, magnetic anchoring patches, or corrosion-resistant grommets configured to interface with manual or pulley-operated systems for secure attachment and repositioning.

### CROSS-REFERENCE TO RELATED APPLICATION

The present application claims priority to, and the benefit of, U.S. Provisional Application No. 63/753,083, which was filed on Feb. 3, 2025, and is incorporated herein by reference in its entirety.

### FIELD OF THE INVENTION

The present invention relates generally to the field of recreational vehicle supports. More specifically, the present invention relates to an inflatable device configured to provide structural elevation beneath fabric-based side toppers typically installed on recreational vehicle slide-outs. Accordingly, the present disclosure makes specific reference thereto. Nonetheless, it is to be appreciated that aspects of the present invention are also equally applicable to other like applications, devices, and methods of manufacture.

### BACKGROUND

Recreational vehicle (RV) owners frequently encounter structural and maintenance issues related to the side topper awnings that cover the slide-out sections of their vehicles. These toppers are generally constructed from flexible fabric materials that are vulnerable to deformation over time. Environmental exposure, mechanical fatigue, and prolonged water or debris accumulation contribute to the sagging of these fabric toppers. This sagging condition often leads to water pooling on the surface, which can infiltrate the RV interior and result in damage to insulation, finishes, or structural components. Repairing water-damaged interiors in RVs can be complex and costly, often requiring the removal and replacement of affected materials. Despite the prevalence of this issue, there is a notable lack of effective, scalable solutions to prevent sagging in RV slide toppers. Owners currently rely on manual draining, makeshift supports, or periodic topper replacement, none of which adequately resolve the problem. An engineered and adaptable solution capable of preventing fabric sagging is needed to preserve the integrity of RV living spaces and reduce maintenance burdens.

Therefore, there exists a long-felt need in the art for an inflatable RV slide topper support device that prevents fabric toppers from sagging under the weight of standing water or accumulated debris. There also exists a long-felt need in the art for an inflatable RV slide topper support device that can be easily installed, adjusted, and secured across a variety of RV configurations. Moreover, there exists a long-felt need in the art for an inflatable RV slide topper support device that is durable, weather-resistant, and capable of targeted elevation in response to variable sagging conditions.

The subject matter disclosed and claimed herein, in one embodiment thereof, comprises an inflatable RV slide topper support device. The device is configured to provide structural elevation beneath fabric-based side toppers typically installed on recreational vehicle slide-outs. The inflatable RV slide topper support device comprises a primary inflatable body that may be tubular in shape. In certain embodiments, the body comprises a plurality of independently inflatable air chambers that allow the user to tailor the support profile based on uneven sagging conditions. The device further comprises at least one inflation valve compatible with manual or powered inflation tools. An exterior surface of the inflatable body may be textured with embossed or patterned regions to enhance friction and prevent slippage against the slide topper and RV roof. The inflatable RV slide topper support device additionally comprises a mounting system that includes reinforced loops, magnetic anchoring patches, or corrosion-resistant grommets configured to interface with manual or pulley-operated systems for secure attachment and repositioning. Optional hydrophobic and anti-fungal coatings are applied to the surface to mitigate microbial growth and moisture retention. Reflective striping may also be included for enhanced visibility during low-light operation.

In this manner, the inflatable RV slide topper support device of the present invention accomplishes all the forgoing objectives and provides a device for elevating sag-prone slide topper surfaces through a controlled inflation process, thereby preventing the pooling of water and accumulation of debris. The optional incorporation of independently inflatable chambers allows for adaptive deployment across uneven or variable sagging conditions, while the variety of cross-sectional profiles and material selections ensures compatibility with different slide-out geometries and environmental exposures. The inclusion of secure mounting features and adjustable anchoring systems facilitates quick installation and removal across various RV models. By addressing the structural vulnerabilities of fabric toppers and mitigating the risk of water damage, the inflatable RV slide topper support device offers a practical, user-configurable, and long-lasting solution for RV owners facing persistent maintenance challenges.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an inflatable RV slide topper support device. The device is configured to reduce sagging and water pooling by providing vertical elevation and structural reinforcement beneath fabric-based slide toppers installed on recreational vehicles. The device is adaptable across various RV classifications and accommodates a range of slide-out lengths, fabric weights, roof inclinations, and environmental conditions.

The device is comprised of an inflatable body that serves as the primary structural element. The body may have a tubular, tapered, stepped, or segmented profile and may be available in multiple cross-sectional shapes, including hexagonal, rectangular, elliptical, or flattened D-shapes, to suit different support dynamics and contact requirements. Multiple length and diameter options are available to fit various slide-out configurations.

In one configuration, the inflatable body is formed as a single continuous air chamber. In an alternate configuration, the body is comprised of multiple air chambers, each independently inflatable. These chambers may be arranged in linear, radial, or nested patterns, allowing targeted elevation and operational redundancy.

The exterior surface of the body is comprised of a durable, weather-resistant material such as UV-stabilized TPU, marine-grade PVC, or reinforced nylon composite. The surface may include hydrophobic and anti-fungal coatings to resist moisture-related degradation. A texture may be applied to the exterior surface to reduce slippage and optimize grip. The texture may be integrally formed or post-processed and may include linear ridges, diamond patterns, or micro-patterns applied either uniformly or in specific zones.

The device is further comprised of a mounting system that secures the inflatable body to the RV structure. The mounting system may include magnetic anchoring patches and reinforced loops, compatible with bungee cords, straps, carabiners, or hook-and-loop wraps. One or more grommets may be included in the mounting system, comprised of corrosion-resistant materials, to interface with manual or pulley-actuated rope systems. These grommets allow ground-level repositioning and elevation adjustments and may be arranged according to RV dimensions and user preference.

The inflatable body includes at least one inflation valve and, in configurations with multiple chambers, may include multiple valves. The valves support inflation via hand pumps, air compressors, or integrated CO₂ cartridges and may include twist-lock, push-to-seal, or dual-action designs.

The body may be manufactured in various color finishes, including neutral tones for visual integration and high-visibility colors for operational awareness. Reflective striping may be applied in linear, segmented, or patterned configurations to improve low-light visibility.

The device is also comprised of a method of using the device. The method includes providing a device comprised of an inflatable body with at least one inflation valve, an exterior surface with optional texture, and a mounting system including grommets and securing elements. The body is positioned beneath the slide topper to provide vertical support, and the valve is actuated to inflate the body until the desired elevation is achieved. In configurations with multiple chambers, individual valves may be used to tailor support. The body is secured to the RV using reinforced loops or grommets, with optional elevation adjustment using a pulley system.

Accordingly, the inflatable RV slide topper support device of the present invention is particularly advantageous as it provides a device for elevating sag-prone slide topper surfaces through a controlled inflation process, thereby preventing the pooling of water and accumulation of debris. The optional incorporation of independently inflatable chambers allows for adaptive deployment across uneven or variable sagging conditions, while the variety of cross-sectional profiles and material selections ensures compatibility with different slide-out geometries and environmental exposures. The inclusion of secure mounting features and adjustable anchoring systems facilitates quick installation and removal across various RV models. By addressing the structural vulnerabilities of fabric toppers and mitigating the risk of water damage, the inflatable RV slide topper support device offers a practical, user-configurable, and long-lasting solution for RV owners facing persistent maintenance challenges.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an inflatable RV slide topper support device of the present invention while inflated in accordance with the disclosed architecture;

FIG. 2 illustrates a perspective view of one potential embodiment of an inflatable RV slide topper support device of the present invention while inflated and placed underneath of and supporting an RV slide topper in accordance with the disclosed architecture; and

FIG. 3 illustrates a flowchart of a method of using one potential embodiment of an inflatable RV slide topper support device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an inflatable RV slide topper support device that prevents fabric toppers from sagging under the weight of standing water or accumulated debris. There also exists a long-felt need in the art for an inflatable RV slide topper support device that can be easily installed, adjusted, and secured across a variety of RV configurations. Moreover, there exists a long-felt need in the art for an inflatable RV slide topper support device that is durable, weather-resistant, and capable of targeted elevation in response to variable sagging conditions.

The present invention, in one exemplary embodiment, is comprised of an inflatable RV slide topper support device. The device is used to prevent sagging and water pooling beneath fabric-based slide toppers installed on recreational vehicles is achieved through the use of a vertically elevating and structurally reinforcing device. Designed for compatibility with multiple RV classifications, the device accommodates diverse slide-out lengths, fabric weights, roof inclinations, and environmental factors.

An inflatable body serves as the primary structural element of the device. The body may be manufactured with a tubular, tapered, stepped, or segmented profile, and offered in a variety of cross-sectional shapes such as hexagonal, rectangular, elliptical, or flattened D-shapes. These variations allow for tailored support dynamics and optimized contact areas, with multiple size options supporting different slide-out configurations.

The inflatable body may be implemented either as a single continuous air chamber or as a plurality of independently inflatable air chambers. These chambers may be arranged in linear, radial, or nested formations to enable targeted elevation and operational continuity in case of localized chamber failure.

The body is constructed from durable, weather-resistant materials such as UV-stabilized TPU, marine-grade PVC, or reinforced nylon composites, the exterior surface of the inflatable body may further incorporate hydrophobic and anti-fungal coatings to resist environmental degradation. A textured finish may also be included, either integrally formed or applied post-manufacture, in uniform or zoned patterns such as ridges, diamonds, or micro-patterns to enhance grip and minimize slippage.

A mounting system is integrated into the device to secure the inflatable body to the RV structure. This system may feature magnetic anchoring patches and reinforced loops compatible with a variety of securing tools, including bungee cords, straps, carabiners, or hook-and-loop wraps. Corrosion-resistant grommets may also be included to facilitate rope-based manual or pulley-actuated repositioning from ground level, with customizable placement to match different RV configurations.

At least one inflation valve is incorporated into the inflatable body, with additional valves included in designs utilizing multiple chambers. These valves support inflation via hand-operated pumps, electric compressors, or integrated CO₂ cartridges and may be implemented using twist-lock, push-to-seal, or dual-action formats.

Color customization of the body can be used for both practical and aesthetic considerations, with neutral tones intended to blend with RV exteriors and high-visibility options included for safety. Reflective striping may also be applied in linear, segmented, or patterned layouts to enhance visibility in low-light conditions.

The invention further encompasses a method for using the inflatable support device. The method involves providing a device with an inflatable body, at least one inflation valve, a textured exterior surface, and a mounting system comprising grommets and securing elements. The inflatable body is positioned beneath the RV slide topper to deliver vertical support, inflated to the desired height, and then secured using the integrated mounting features. For configurations with multiple chambers, support may be selectively adjusted by inflating individual chambers. Pulley-based systems may also be used for repositioning from ground level.

As a result, the inflatable RV slide topper support device offers substantial advantages by elevating sagging slide topper surfaces through a controlled inflation process, thereby preventing water accumulation and debris buildup. The use of independently inflatable chambers allows for adaptive support under uneven conditions, while variable cross-sectional profiles and robust materials ensure versatility across different slide-out geometries and environmental demands. Secure and adjustable mounting features enable efficient installation and removal, providing RV owners with a durable, customizable, and practical solution for common slide topper maintenance issues.

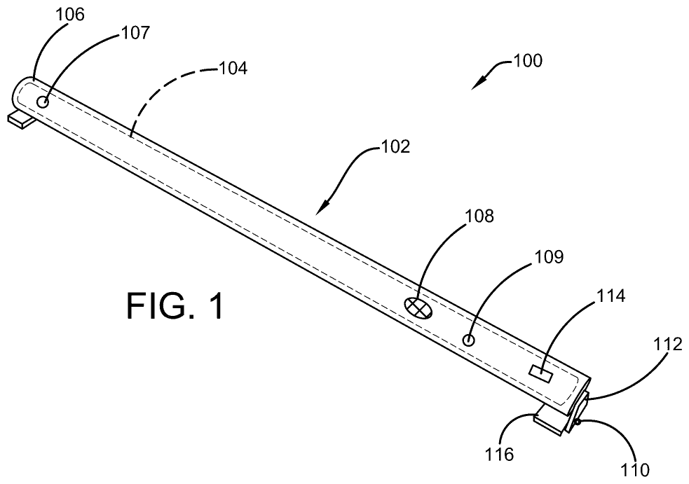

Referring initially to the drawings, FIG. 1 illustrates a perspective view of one potential embodiment of an inflatable RV slide topper support device 100 of the present invention while inflated in accordance with the disclosed architecture. The device 100 is configured to mitigate sagging and related complications such as water pooling by providing vertical elevation and structural reinforcement beneath fabric-based slide toppers 10 typically installed on recreational vehicles (RVs). The device 100 may be operable across various RV classifications, including but not limited to class A motorhomes, class C motorhomes, fifth-wheel trailers, bumper pull campers, etc. The adaptability of the device 100 may accommodate a range of slide-out lengths, fabric weights, roof inclinations, and environmental conditions.

The device 100 may be comprised of an inflatable body 102 that functions as the primary structural element. In one embodiment, the body 102 is tubular with a uniform diameter and cylindrical profile. In alternate embodiments, the body 102 may exhibit a non-uniform profile such as a tapered, stepped, or segmented contour, to conform to specific slide topper geometries or to optimize weight distribution. The cross-sectional shape of the body 102 may vary and may include configurations such as hexagonal, rectangular, elliptical, or flattened D-shapes, depending on the desired contact area and support dynamics. To accommodate diverse RV slide-out configurations, the body 102 may be available in multiple lengths and diameters.

In a preferred configuration, the body 102 functions as a single continuous air chamber. In an alternate configuration, the body 102 is comprised of a plurality of air chambers 104 (as seen in FIG. 1), wherein each chamber 104 may be separately inflated. These individual chambers 104 may be arranged in a linear, radial, or nested pattern. Independent inflation capability for each chamber 104 enables users to target elevation in uneven or specific locations where sagging is more severe. Furthermore, the presence of multiple chambers 104 may offer redundancy such that the failure of one chamber 104 does not impair the performance of the device 100 as a whole.

The exterior surface 106 of the body 102 may be comprised of a durable, weather-resistant material such as UV-stabilized thermoplastic polyurethane (TPU), marine-grade polyvinyl chloride (PVC), reinforced nylon composite, laminated multilayer textiles, etc. Each material may be selected based on mechanical flexibility, puncture resistance, temperature tolerance, and compatibility with inflatable construction techniques such as RF welding or ultrasonic seam bonding. The surface 106 may be coated with a hydrophobic coating 107 and/or an anti-fungal coating 109 to resist mold accumulation when exposed to moisture-rich environments.

A texture 108 may be applied to the exterior surface 106 and may be formed integrally or post-processed and may vary by region, as seen in FIG. 1. A uniform embossing pattern may be used across the entire surface 106 to reduce sliding, or various textured zones may be strategically placed to provide grip only at contact interfaces. The texture 108 may include, but is not limited to linear ridges, diamond patterns, stipples, micro-patterns, etc. that optimize friction with both rigid and textile substrates.

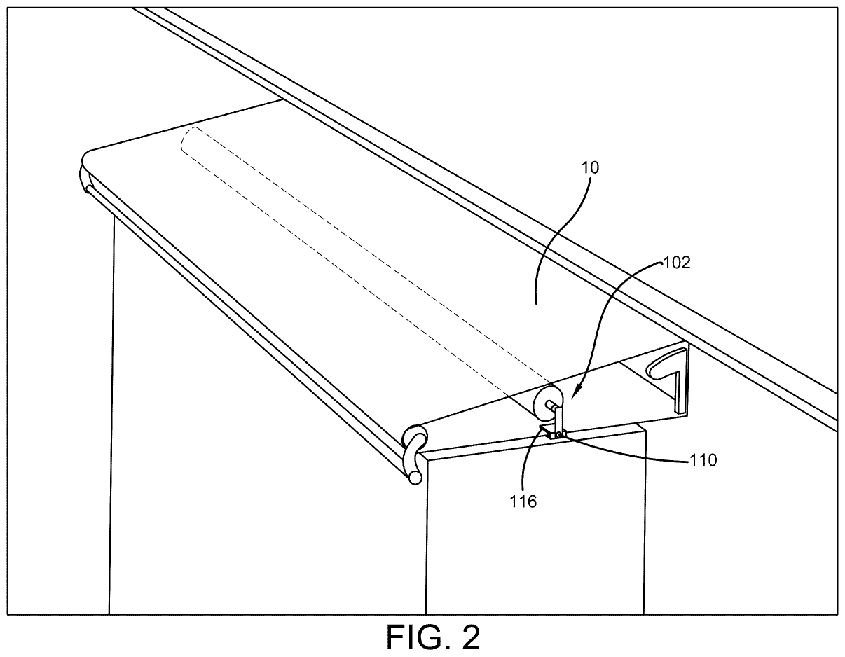

The device 100 may be further comprised of a mounting system 116 that secures the body 102 to the RV structure during deployment, as seen in FIG. 2. The mounting system 116 may be but is not limited to magnetic anchoring patches, a magnet, or reinforced loops which may be stitched, welded, or integrally molded into the body 102 that can accept a variety of securing implements such as bungee cords, tension straps, carabiners, or hook-and-loop wraps, etc.

Additionally, the mounting system 116 may include one or more grommets 110 (as seen in FIG. 1 and FIG. 2), which may be comprised of corrosion-resistant metals or composite polymers. The grommet 110 may be configured to interface with a manual or pulley-actuated rope system that allows the user to elevate, retract, or reposition the device 100 from ground level. The location and number of grommets 110 may vary to accommodate RV height, slide-out dimensions, and user preference.

The body 102 may be equipped with at least one inflation valve 112, and in some embodiments, a plurality of valves 112 may be distributed along the body 102 for each chamber 104. The valve 112 may be any type of valve such as but not limited to twist-lock, push-to-seal, dual-action, etc. that permits inflation with manual hand pumps, powered air compressors, or integrated CO₂ cartridges.

The body 102 may be manufactured in a variety of color finishes to suit both aesthetic and practical concerns. Color options may include but are not limited to neutral tones such as gray, beige, charcoal, and earth-brown to blend with most RV exteriors. High-visibility options may include but are not limited to safety orange, fluorescent yellow, or bright red for operational awareness. In addition, reflective striping 114 may be bonded or laminated onto the surface 106, using retroreflective materials that enhance detection under low-light or night-time conditions. The reflective striping 114 may be linear, segmented, or patterned to improve visibility from various angles and distances.

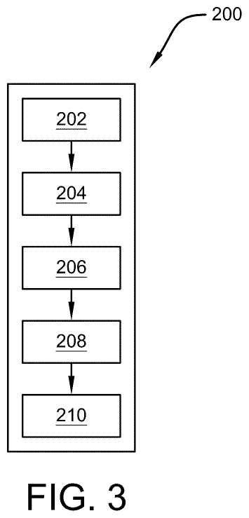

The present invention is also comprised of a method of using 200 the device 100, as seen in FIG. 3. First, a device 100 is provided comprised of an inflatable body 102 having at least one inflation valve 112, at least one exterior surface 106 with optional texture 108, and at least one mounting system 116 comprising grommets 110 and securing means such as magnetic patches 118 or reinforced loops 120 [Step 202]. Then, the inflatable body 102 can be positioned beneath the fabric-based slide topper 10 of a recreational vehicle such that it provides vertical support between the slide topper and the underlying slide-out roof structure [Step 204]. Next, the inflation valve 112 can be actuated to introduce air into the body 102, thereby elevating the body 102 until the desired support height is achieved to counteract sagging or water pooling in the slide topper [Step 206]. If the body 102 is comprised of a plurality of air chambers 104, each valve 112 may be independently actuated to selectively inflate specific chambers 104 in order to tailor the support profile to uneven sagging conditions [Step 208]. Following inflation, the mounting system 116 can be used to secure the body 102 to the RV structure by engaging the reinforced loops 120 or grommets 110 with securing implements such as straps or ropes, and optionally employing a pulley-actuated system to elevate or adjust the position of the body 102 from ground level [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “inflatable RV slide topper support device” and “device” are interchangeable and refer to the inflatable RV slide topper support device 100 of the present invention.

Notwithstanding the forgoing, the inflatable RV slide topper support device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the inflatable RV slide topper support device 100 as shown in the FIGS. are for illustrative purposes only, and that many other sizes and shapes of the inflatable RV slide topper support device 100 are well within the scope of the present disclosure. Although the dimensions of the inflatable RV slide topper support device 100 are important design parameters for user convenience, the inflatable RV slide topper support device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inflatable RV slide topper support device comprising:
an inflatable body;
a mounting system;
a grommet; and
an inflation valve.

2. The inflatable RV slide topper support device of claim 1, wherein an exterior surface of the inflatable body is comprised of a hydrophobic coating.

3. The inflatable RV slide topper support device of claim 1, wherein an exterior surface of the inflatable body is comprised of an anti-fungal coating.

4. The inflatable RV slide topper support device of claim 1, wherein an exterior surface of the inflatable body is comprised of a texture.

5. The inflatable RV slide topper support device of claim 1, wherein the mounting system is comprised of a magnet.

6. The inflatable RV slide topper support device of claim 1, wherein the mounting system is comprised of a loop.

7. The inflatable RV slide topper support device of claim 1, wherein the inflation valve is comprised of a twist-lock valve.

8. The inflatable RV slide topper support device of claim 1, wherein the inflation valve is comprised of a push-to-seal valve.

9. The inflatable RV slide topper support device of claim 1, wherein the inflation valve is comprised of a dual-action valve.

10. An inflatable RV slide topper support device comprising:
an inflatable body comprised of a plurality of air chambers;
a mounting system;
a grommet; and
an inflation valve.

11. The inflatable RV slide topper support device of claim 10, wherein the inflatable body is comprised of a reflective striping.

12. The inflatable RV slide topper support device of claim 10, wherein an exterior surface of the inflatable body is comprised of a hydrophobic coating.

13. The inflatable RV slide topper support device of claim 10, wherein an exterior surface of the inflatable body is comprised of an anti-fungal coating.

14. The inflatable RV slide topper support device of claim 10, wherein an exterior surface of the inflatable body is comprised of a texture.

15. The inflatable RV slide topper support device of claim 10, wherein the mounting system is comprised of a magnet.

16. The inflatable RV slide topper support device of claim 10, wherein the mounting system is comprised of a loop.

17. The inflatable RV slide topper support device of claim 10, wherein the inflation valve is comprised of a twist-lock valve.

18. The inflatable RV slide topper support device of claim 10, wherein the inflation valve is comprised of a push-to-seal valve.

19. The inflatable RV slide topper support device of claim 10, wherein the inflation valve is comprised of a dual-action valve.

20. A method of using an inflatable RV slide topper support device, the method comprising the following steps:
providing an inflatable RV slide topper support device comprised of an inflatable body having an inflation valve, a grommet, and a mounting system;
positioning the inflatable body beneath a slide topper of a recreational vehicle such that the inflatable body provides vertical support between the slide topper and an underlying slide-out roof structure of the recreational vehicle;
actuating the inflation valve to introduce an air into the inflatable body until a desired support height of the inflatable body is achieved; and
using the mounting system to secure the inflatable body to a structure of the recreational vehicle.
